(19) United States
(12) Patent Application Publication
(10) Pub. No.: US 2007/0108652 A1
(43) Pub. Date: May 17, 2007

(54) Fluoroplastic silicone vulcanizates

(76) Inventors: Igor Chorvath, Midland, MI (US); Lauren Tonge, Sanford, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 10/581,758

(22) PCT Filed: Dec. 13, 2004
(86) PCT No.: PCT/US04/41703

§ 371 Date: Jun. 5, 2006

Related U.S. Application Data
(60) Provisional application No. 60/529,710, filed on Dec. 15, 2003.

(51) Int. Cl. B29C 47/60

(52) U.S. Cl. 264/211.23; 264/211.24

(57) ABSTRACT

A method for preparing a fluoroplastic silicone composition is disclosed containing both a fluoroplastic and a cured organopolysiloxane using dynamic vulcanization techniques. A silicone compound containing a curable organopolysiloxane is first prepared, mixed with a fluoroplastic, and then cured via dynamic vulcanization.

This invention relates to a method for preparing a fluoroplastic silicone composition containing both a fluoroplastic and a cured organopolysiloxane using dynamic vulcanization techniques. A silicone compound containing a curable organopolysiloxane is first prepared, mixed with a fluoroplastic, and then cured via dynamic vulcanization.

Fluoroplastics are commonly selected to prepare various thermoplastic articles for use in harsh chemical and/or thermal conditions. For example many automotive hoses, gaskets, and seals are prepared from fluoroplastics. However, in some of these applications, there is a need to improve the impact resistance of the fluoroplastic, or alternatively, to improve the flexural modulus of the fluoroplastic.

One possible approach to improving the impact resistance of the fluoroplastic is to incorporate a rubbery or elastomeric material into the fluoroplastic. For example, incorporation of a silicone elastomer into a fluoroplastic improves impact resistance of the fluoroplastic. However, incorporating a silicone elastomer into the fluoroplastic is not easily achieved because of the inherent incompatibilities between two such phases.

The present inventors have discovered a new process for preparing fluoroplastics having improved impact resistance or alternatively having lower flexural modulus. The process incorporates an uncured silicone compound into a fluoroplastic, and the silicone compound is subsequently cured within the fluoroplastic via dynamic vulcanization techniques. The resulting fluoroplastic silicone vulcanizates have improved properties, as measured by impact resistance or by flexural modulus, verses the fluoroplastic alone.

Dynamic vulcanization techniques have been used to prepare thermoplastic elastomer compositions based on fluorocarbon resins, such as taught in U.S. Pat. No. 6,015,858. The '858 patent compositions are based on the use of a modified fluorocarbon resin with a silicone base.

This invention provides a method for preparing a fluoroplastic silicone composition containing both a fluoroplastic, and a cured organopolysiloxane. Thus, the present invention provides a method for preparing a fluoroplastic silicone composition comprising:

(I) mixing
(A) a silicone base comprising a curable organopolysiloxane,
(B) an optional crosslinking agent,
(C) a cure agent, to form a silicone compound;

(II) mixing the silicone compound with
(D) a fluoroplastic,
(E) an optional compatibilizer,
(F) an optional catalyst;
   and

(III) dynamically vulcanizing the silicone compound,

wherein the weight ratio of fluoroplastic (D) to silicone base (A) in the fluoroplastic silicone composition ranges from 95:5 to 25:75.

The invention further relates to the fluoroplastic silicone compositions obtained by the present method, and articles of manufacture comprising the fluoroplastic silicone compositions.

In a first embodiment of the present invention, fluoroplastic silicone compositions having improved impact resistance properties are provided by the present process wherein the weight ratio of fluoroplastic (D) to silicone base (A) in the fluoroplastic silicone composition ranges from 95:5 to 25:75.

In a second embodiment of the present invention, fluoroplastic silicone compositions having lower flexural modulus are provided by the present process wherein the weight ratio of fluoroplastic (D) to silicone base (A) in the fluoroplastic silicone composition ranges from 25:75 to 75:25.

The first step (I) of the method of the present invention is mixing;
(A) a silicone base comprising a curable organopolysiloxane,
(B) an optional crosslinking agent,
(C) a cure agent,
   to form a silicone compound.

Component (A) is a silicone base comprising a curable organopolysiloxane (A′) and optionally, a filler (A″). A curable organopolysiloxane is defined herein as any organopolysiloxane having at least two curable groups present in its molecule. Organopolysiloxanes are well known in the art and are often designated as comprising any number of M units (R₃SiO_{0.5}), D units (R₂SiO), T units (RSiO_{1.5}), or Q units (SiO₂) where R is independently any monovalent hydrocarbon group. Alternatively, organopolysiloxanes are often described as having the following general formula, [RₘSi(O)_{4-m/2}]ₙ, where R is independently any monovalent hydrocarbon group and m=1−3, and n is at least two.

The organopolysiloxane in the silicone base (A) must have at least two curable groups in its molecule. As used herein, a curable group is defined as any hydrocarbon group that is capable of reacting with itself or another hydrocarbon group, or alternatively with a crosslinker to crosslink the organopolysiloxane. This crosslinking results in a cured organopolysiloxane. Representative of the types of curable organopolysiloxanes that can be used in the silicone base are the organopolysiloxanes that are known in the art to produce silicone rubbers upon curing. Representative, non-limiting examples of such organopolysiloxanes are disclosed in “Encyclopedia of Chemical Technology”, by Kirk-Othmer, 4^{th} Edition, Vol. 22, pages 82-142, John Wiley & Sons, NY which is hereby incorporated by reference. Typically, organopolysiloxanes can be cured via a number of crosslinking mechanisms employing a variety of cure groups on the organopolysiloxane, cure agents, and optional crosslinking agent. While there are numerous crosslinking mechanisms, three of the more common crosslinking mechanisms used in the art to prepare silicone rubbers from curable organopolysiloxanes are free radical initiated crosslinking, hydrosilylation or addition cure, and condensation cure. Thus, the curable organopolysiloxane can be selected from, although not limited to, any organopolysiloxane capable of undergoing any one of these aforementioned crosslinking mechanisms. The selection of components (A), (B), and (C) are made consistent with the choice of cure or crosslinking mechanisms. For example if hydrosilylation or addition cure is selected, then a silicone base comprising an organopolysiloxane with at least two alkenyl groups (curable groups) would be used as component (A′), an organohydrido silicon compound would be used as component (B), and a platinum catalyst would be used as component (C). For condensation cure, a silicone base comprising an organopolysiloxane having at least 2 silicon bonded hydroxy groups or hydrolysable precursors of hydroxy groups (ie silanol or alkoxy silanes, are considered as the curable groups) would be selected as component (A) and a condensation cure catalyst known in the art, such as a tin catalyst, would be selected as component (C). For free radical initiated crosslinking, any organopolysiloxane can be selected as component (A), and a free radical initiator would be selected as component (C) if the combination will cure within the time and temperature constraints of the dynamic vulcanization step (III). Depending on the selection of component (C) in such free radical initiated crosslinking, any alkyl group, such as methyl, can be considered as the curable groups, since they would crosslink under such free radical initiated conditions.

The quantity of the silicone compound, i.e. the mixture comprising components (A), (B) and (C), used can vary depending on the amount of fluoroplastic (D) used. However, it is typical to use levels of fluoroplastic (D) of 25 to 95 wt. %. It is convenient to report the weight ratio of fluoroplastic (D) to the silicone base (A) which typically ranges from 95:5 to 25:75

Typically, the amount of component (C) used varies depending on the selection of the organopolysiloxane and cure system. However, an amount (C) sufficient to cure said organopolysiloxane should be used, and can be determined by routine experimentation.

In the addition cure embodiment of the present invention, the selection of components (A), (B), and (C) can be made to produce a silicon rubber during the vulcanization process via hydrosilylation cure techniques. This embodiment is herein referred to as the hydrosilylation cure embodiment. Thus, in the hydrosilylation cure embodiment, (A′) is selected from a diorganopolysiloxane which contains at least 2 alkenyl groups having 2 to 20 carbon atoms and optionally (A″), a reinforcing filler. The alkenyl group is specifically exemplified by vinyl, allyl, butenyl, pentenyl, hexenyl and decenyl, preferably vinyl or hexenyl. The position of the alkenyl functionality is not critical and it may be bonded at the molecular chain terminals, in non-terminal positions on the molecular chain or at both positions. Typically, the alkenyl group is vinyl or hexenyl and that this group is present at a level of 0.0001 to 3 mole percent, alternatively 0.0005 to 1 mole percent, in the diorganopolysiloxane. The remaining (i.e., non-alkenyl) silicon-bonded organic groups of the diorganopolysiloxane are independently selected from hydrocarbon or halogenated hydrocarbon groups which contain no aliphatic unsaturation. These may be specifically exemplified by alkyl groups having 1 to 20 carbon atoms, such as methyl, ethyl, propyl, butyl, pentyl and hexyl; cycloalkyl groups, such as cyclohexyl and cycloheptyl; aryl groups having 6 to 12 carbon atoms, such as phenyl, tolyl and xylyl; aralkyl groups having 7 to 20 carbon atoms, such as benzyl and phenylethyl; and halogenated alkyl groups having 1 to 20 carbon atoms, such as 3,3,3-trifluoropropyl and chloromethyl. It will be understood, or course, that these groups are selected such that the diorganopolysiloxane has a glass temperature below room temperature and the cured polymer is therefore elastomeric. Typically, the non-alkenyl silicon-bonded organic groups in the diorganopolysiloxane makes up at least 85, or alternatively at least 90 mole percent, of the organic groups in the diorganopolysiloxanes.

Thus, dipolyorganosiloxane (A′) can be a homopolymer, a copolymer or a terpolymer containing such organic groups. Examples include homopolymers comprising dimethylsiloxy units, homopolymers comprising 3,3,3-trifluoropropylmethylsiloxy units, copolymers comprising dimethylsiloxy units and phenylmethylsiloxy units, copolymers comprising dimethylsiloxy units and 3,3,3-trifluoropropylmethylsiloxy units, copolymers of dimethylsiloxy units and diphenylsiloxy units and interpolymers of dimethylsiloxy units, diphenylsiloxy units and phenylmethylsiloxy units, among others. The molecular structure is also not critical and is exemplified by straight-chain and partially branched straight-chain structures, the linear systems being the most typical.

Specific illustrations of diorganopolysiloxane (A′) include:

trimethylsiloxy-endblocked dimethylsiloxane-methylvinylsiloxane copolymers;

trimethylsiloxy-endblocked methylphenylsiloxane-dimethylsiloxane-methylvinylsiloxane copolymers; trimethylsiloxy-endblocked 3,3,3-trifluoropropylmethyl siloxane copolymers;

trimethylsiloxy-endblocked 3,3,3-trifluoropropylmethyl-methylvinylsiloxane copolymers;

dimethylvinylsiloxy-endblocked dimethylpolysiloxanes;

dimethylvinylsiloxy-endblocked dimethylsiloxane-methylvinylsiloxane copolymers;

dimethylvinylsiloxy-endblocked methylphenylpolysiloxanes;

dimethylvinylsiloxy-endblocked methylphenylsiloxane-dimethylsiloxane-methylvinylsiloxane copolymers; and similar copolymers wherein at least one end group is dimethylhydroxysiloxy.

The organopolysiloxane may also consist of combinations of two or more organopolysiloxanes. Alternatively, diorganopolysiloxane (A′) is a linear polydimethylsiloxane homopolymer and is preferably terminated with a vinyl group at each end of its molecule or it is such a homopolymer which also contains at least one vinyl group along its main chain.

For the purposes of the present invention, the preferred diorganopolysiloxane is a diorganopolysiloxane gum with a molecular weight sufficient to impart a Williams plasticity number of at least about 30 as determined by the American Society for Testing and Materials (ASTM) test method 926. Although there is no absolute upper limit on the plasticity of component (A′), practical considerations of processability in conventional mixing equipment generally restrict this value. Typically, the plasticity number should be 40 to 200, or alternatively 50 to 150.

Methods for preparing high consistency unsaturated group-containing diorganopolysiloxanes are well known, and they do not require a detailed discussion in this specification.

Optional component (A″) is any filler which is known to reinforce diorganopolysiloxane (A′) and is preferably selected from finely divided, heat stable minerals such as fumed and precipitated forms of silica, silica aerogels and titanium dioxide having a specific surface area of at least about 50 m²/gram. The fumed form of silica is a typical reinforcing filler based on its high surface area, which can be up to 450 m²/gram. Alternatively, a fumed silica having a surface area of 50 to 400 m²/g, or alternatively 90 to 380 m²/g, can be used. The filler is added at a level of about 5 to about 150 parts by weight, alternatively 10 to 100 or alternatively 15 to 70 parts by weight, for each 100 parts by weight of diorganopolysiloxane (A′).

The filler is typically treated to render its surface hydrophobic, as typically practiced in the silicone rubber art. This can be accomplished by reacting the silica with a liquid organosilicon compound which contains silanol groups or hydrolyzable precursors of silanol groups. Compounds that can be used as filler treating agents, also referred to as anti-creping agents or plasticizers in the silicone rubber art, include such ingredients as low molecular weight liquid hydroxy- or alkoxy-terminated polydiorganosiloxanes, hexaorganodisiloxanes, cyclodimethylsilazanes and hexaorganodisilazanes.

Component (A) may also contain other materials commonly used in silicone rubber formulations including, but not limited to, antioxidants, crosslinking auxiliaries, processing agents, pigments, and other additives known in the art which do not interfere with step (III) described infra.

In the hydrosilylation cure embodiment of the present invention, compound (B) is added and is an organohydrido silicon compound (B′), that crosslinks with the diorganopolysiloxane (A′). The organohydrido silicon compound is an organopolysiloxane which contains at least 2 silicon-bonded hydrogen atoms in each molecule which are reacted with the alkenyl functionality of (A′) during the dynamic vulcanization step (III) of the present method. A further (molecular weight) limitation is that Component (B′) must have at least about 0.1 weigh percent hydrogen, alternatively 0.2 to 2 or alternatively 0.5 to 1.7, percent hydrogen bonded to silicon. Those skilled in the art will, of course, appreciate that either the diorganopolysiloxane (A′) or component (B′), or both, must have a functionality greater than 2 to cure the diorganopolysiloxane (i.e., the sum of these functionalities must be greater than 4 on average). The position of the silicon-bonded hydrogen in component (B′) is not critical, and it may be bonded at the molecular chain terminals, in non-terminal positions along the molecular chain or at both positions. The silicon-bonded organic groups of component (B′) are independently selected from any of the saturated hydrocarbon or halogenated hydrocarbon groups described above in connection with diorganopolysiloxane (A′), including preferred embodiments thereof. The molecular structure of component (B′) is also not critical and is exemplified by straight-chain, partially branched straight-chain, branched, cyclic and network structures, network structures, linear polymers or copolymers being typical. It will, of course, be recognized that this component must be compatible with A′ (i.e., it is effective in curing the diorganopolysiloxane).

Component (B′) is exemplified by the following:

low molecular weight siloxanes such as PhSi(OSiMe₂H)₃;

trimethylsiloxy-endblocked methylhydridopolysiloxanes;

trimethylsiloxy-endblocked dimethylsiloxane-methylhydridosiloxane copolymers;

dimethylhydridosiloxy-endblocked dimethylpolysiloxanes;

dimethylhydrogensiloxy-endblocked methylhydrogenpolysiloxanes;

dimethylhydridosiloxy-endblocked dimethylsiloxane-methylhydridosiloxane copolymers;

cyclic methylhydrogenpolysiloxanes;

cyclic dimethylsiloxane-methylhydridosiloxane copolymers;

tetrakis(dimethylhydrogensiloxy)silane; trimethylsiloxy-endblocked methylhydridosiloxane polymers containing SiO_{4/2} units; silicone resins composed of (CH₃)₂HSiO_{1/2}, and SiO_{4/2} units; silicone resins composed of (CH₃)₂HSiO_{1/2}, (CH₃)₃SiO_{1/2}, and SiO_{4/2} units; silicone resins composed of (CH₃)₂HSiO_{1/2} and CF₃CH₂CH₃SiO_{3/2}; and

silicone resins composed of (CH₃)₂HSiO_{1/2}, (CH₃)₃SiO_{1/2},

CH₃SiO_{3/2}, PhSiO_{3/2} and SiO_{4/2} units,

wherein Ph hereinafter denotes phenyl radical.

Typical organohydrido silicon compounds are polymers or copolymers comprising RHSiO units terminated with either R₃SiO_{1/2} or HR₂SiO_{1/2} units wherein R is independently selected from alkyl radicals having 1 to 20 carbon atoms, phenyl or trifluoropropyl, typically methyl. Also, typically the viscosity of component (B′) is about 0.5 to 3,000 mPa·s at 25° C., alternatively 1 to 2000 mPa·s. Component (B′) typically has 0.5 to 1.7 weight percent hydrogen bonded to silicon. Alternatively, component (B′) is selected from a polymer consisting essentially of methylhydridosiloxane units or a copolymer consisting essentially of dimethylsiloxane units and methylhydridosiloxane units, having 0.5 to 1.7 weight percent hydrogen bonded to silicon and having a viscosity of 1 to 2000 mPa·s at 25° C. Such a typical system has terminal groups selected from trimethylsiloxy or dimethylhydridosiloxy groups. Alternatively, component (B′) is selected from copolymer or network structures comprising resin units. The copolymer or network structures units comprise RSiO_{3/2} units or SiO_{4/2} units, and may also contain R₃SiO_{1/2}, R₂SiO_{2/2}, and or RSiO_{3/2} units wherein R is independently selected from hydrogen or alkyl radicals having 1 to 20 carbon atoms, phenyl or trifluoropropyl, typically methyl. It is understood that sufficient R as hydrogen is selected such that component (B′) typically has 0.5 to 1.7 weight percent hydrogen bonded to silicon. Also, typically the viscosity of component (B′) is about 0.5 to 3,000 mPa·s at 25° C., alternatively 1 to 2000 mPa·s. Component (B′) may also be a combination of two or more of the above described systems.

The organohydrido silicon compound (B′) is used at a level sufficient to cure diorganopolysiloxane (A′) in the presence of component (C), described infra. Typically, its content is adjusted such that the molar ratio of SiH therein to Si-alkenyl in (A′) is greater than 1. Typically, this SiH/alkenyl ratio is below about 50, alternatively 1 to 20 or alternatively 1 to 12. These SiH-functional materials are well known in the art and many are commercially available.

In the hydrosilylation cure embodiment of the present invention, component (C) is a hydrosilation catalyst (C′), that accelerates the cure of the diorganopolysiloxane. It is exemplified by platinum catalysts, such as platinum black, platinum supported on silica, platinum supported on carbon, chloroplatinic acid, alcohol solutions of chloroplatinic acid, platinum/olefin complexes, platinum/alkenylsiloxane complexes, platinum/beta-diketone complexes, platinum/phosphine complexes and the like; rhodium catalysts, such as rhodium chloride and rhodium chloride/di(n-butyl)sulfide complex and the like; and palladium catalysts, such as palladium on carbon, palladium chloride and the like. Component (C′) is typically a platinum-based catalyst such as chloroplatinic acid; platinum dichloride; platinum tetrachloride; a platinum complex catalyst produced by reacting chloroplatinic acid and divinyltetramethyldisiloxane which is diluted with dimethylvinylsiloxy endblocked polydimethylsiloxane, prepared according to U.S. Pat. No. 3,419,593 to Willing; and a neutralized complex of platinous chloride and divinyltetramethyldisiloxane, prepared according to U.S. Pat. No. 5,175,325 to Brown et al., these patents being hereby incorporated by reference. Alternatively, catalyst (C′) is a neutralized complex of platinous chloride and divinyltetramethyldisiloxane.

Component (C′) is added to the present composition in a catalytic quantity sufficient to promote the reaction between diorganopolysiloxane (A′) and component (B′) so as to cure the diorganopolysiloxane within the time and temperature limitations of the dynamic vulcanization step (III). Typically, the hydrosilylation catalyst is added so as to provide about 0.1 to 500 parts per million (ppm) of metal atoms based on the weight of the silicone base (A), alternatively 0.25 to 50 ppm.

In another embodiment, components (A), (B), and (C) are selected to provide a condensation cure of the organopolysiloxane. For condensation cure, an organopolysiloxane having at least 2 silicon bonded hydroxy groups or hydrolysable precursors of hydroxy groups (i.e. silanol or alkoxysilanes are considered as the curable groups) would be selected as component (A), and a condensation cure catalyst known in the art, such as a tin catalyst, would be selected as component (C). The organopolysiloxanes useful as condensation curable organopolysiloxanes are one or more organopolysiloxanes which contains at least 2 silicon bonded hydroxy groups or hydrolysable precursors of hydroxy groups (or silanol groups (SiOH)) in its molecule. Typically, any of the organopolysiloxanes described infra as component (A) in the addition cure embodiment, can be used as the organopolysiloxane in the condensation cure embodiment if at least two SiOH groups or SiOH precursors are additionally present, although the alkenyl group would not be necessary in the condensation cure embodiment. The organohydrido silicon compound useful as the optional crosslinking agent (B) is the same as described infra for component (B). However, more typically, the crosslinker is selected from a alkoxy or acetoxy endblocked organopolysiloxanes, that are known in the art for effecting condensation cure of organopolysiloxanes. The condensation catalyst useful as the curing agent in this embodiment is any compound which will promote the condensation reaction between the SiOH groups of diorganopolysiloxane (A) and the reaction between the SiOH groups of diorganopolysiloxane (A) and the reactive groups of the optional crosslinking agent (B), when present, so as to cure the former by the formation of—Si—O—Si—bonds. Examples of suitable catalysts include metal carboxylates, such as dibutyltin diacetate, dibutyltin dilaurate, tin tripropyl acetate, stannous octoate, stannous oxalate, stannous naphthanate; amines, such as triethyl amine, ethylenetriamine; and quaternary ammonium compounds, such as benzyltrimethylammoniumhydroxide, beta-hydroxyethylltrimethylammonium-2-ethylhexoate and beta-hydroxyethylbenzyltrimethyldimethylammoniumbutoxide (see, e.g., U.S. Pat. No. 3,024,210).

In yet another embodiment, components (A), (B), and (C) can be selected to provide a free radical cure of the organopolysiloxane. In this embodiment, the organopolysiloxane can be any organopolysiloxane but typically, the organopolysiloxane has at least 2 alkenyl groups. Thus, any of the organopolysiloxane described supra as suitable choices for (A′) in the addition cure embodiment can also be used in the free radical embodiment of the present invention. A crosslinking agent (B) is not required, but may aid in the free radical cure embodiment. The cure agent (C) can be selected from any of the free radical initiators described infra for the selection of component (F).

Step (I) of the method produces a mixture comprising components (A), optionally (B), and (C), herein referred to as “a silicone compound”. Typically, but not required, the silicone compound can be considered as a silicone rubber premix because subsequent vulcanization of this mixture results in a cured silicone rubber. Thus, any mixing techniques, known for mixing such elastomeric materials, can be employed in the mixing step (I), including but not limited to mixers, kneaders or rolls and extrusion processes.

The silicone compound of step (I) can also be selected from any commercially available silicone compounds that can be considered as silicone rubber precursor compositions, providing the silicone compound comprises at least components (A) and (C) as described supra.

Component (D) of the present invention is a melt processable semicrystalline fluoroplastic having a melt point (Tₘ) above room temperature (RT) or amorphous fluoroplastic having a glass transition temperature (Tg) above room temperature. Representative, non-limiting examples of Fluoroplastics can be found in summary articles of this class of materials such as in: “Vinylidene Fluoride-Based Thermoplastics (Overview and Commercial Aspects)”, J. S. Humphrey, Jr., “Tetrafluoroethylene Copolymers (Overview)”, T. Takakura, “Fluorinated Plastics Amorphous”, M. H. Hung, P. R. Resnick, B. E. Smart, W. H. Buck all of Polymeric Material Encyclopedia, 1996 Version 1.1, CRC Press, NY; “Fluoropolymers”, K-L. Ring, A. Leder, and M Ishikawa-Yamaki, Chemical Economics Handbook-SRI International 2000, Plastics and Resins 580.0700A, all of which are hereby incorporated by reference. Thus, it is contemplated that the fluoroplastic may be a homopolymer, copolymer, or terpolymer of the following fluorine containing monomers selected from the list: tetrafluoroethylene, vinylidene difluoride, chlorotrifluoroethylene, and vinyl fluoride. Commercially available examples are illustrated by but not limited to: poly(vinylidene difluoride), (PVDF); poly(ethylene-tetrafluoroethylene), (E-TEF); hexafluoropropylene/vinylidene fluoride (PVDF/HFP); tetrafluoroethylene/hexafluoropropylene/vinylidene fluoride, (THV); fluorinated ethylene propylene (FEP) and poly(ethylene-chlorotrifluoroethylene), (E-CTFE),

It is anticipated that the fluoroplastic (D), can be a mixture of fluoroplastics. However, in the chemically modified embodiment, at least 2 wt. %, alternatively at least 5 wt. %, alternatively at least 10 wt. % of the fluoroplastic is a polymer, copolymer, or terpolymer which is prepared from at least one monomer containing olefinic groups or monomers containing one of the following groups: a carbon-bonded hydrogen or carbon-bonded chlorine or carbon-bonded bromine or carbon-bonded iodine.

According to the method of the present invention, the fluoroplastic (D), the silicone base (A) or the silicone compound is mixed with an optional compatibilizer (E) in the presence of an optional catalyst (F) to produce a modified fluoroplastic or a modified silicone. The structure of the compatibilizer is not critical. The function of the compatibilizer is to modify the fluoroplastic or silicone in such a manner so as to produce a fluoroplastic/silicone mixture which upon dynamic vulcanization of silicone (III) will produce a fluoroplastic silicone composition having a continuous fluoroplastic phase and a discontinuous cured (i.e. internal) silicone phase. Thus, compatibilizer (E) can be selected from any hydrocarbon, organosiloxane, fluorocarbon, fluoroplastic, or combinations thereof that would be expected to modify the fluoroplastic or silicone in a manner to enhance the mixing of the silicone with the fluoroplastic (D) to produce a mixture having a continuous fluoroplastic phase and a discontinuous (i.e. internal) silicone phase. However, the compatibilizer, or the resulting modified composition, must not prevent the dynamic cure of the organopolysiloxane component, described infra.

In the physically modified embodiment, the compatibilizer (E) can be selected from any compatibilizer known in the art to enhance the mixing of a silicone with a fluoroplastic. Typically, such compatibilizers are the reaction product of a organopolysiloxane and a fluorocarbon or fluoroplastic polymer. Representative non-limiting examples of such compatibilizers are described in U.S. Pat. Nos. 5,554,689 and 6,035,780, both of which are incorporated by reference herein.

In the chemically modified embodiment, typically the compatibilizer (E) can be selected from (E¹) organic (i.e., non-silicone) compounds which contain 2 or more olefin groups, (E²) organopolysiloxanes containing at least 2 alkenyl groups, (E³) olefin-functional silanes which also contain at least one hydrolyzable group or at least one hydroxyl group attached to a silicon atom thereof, (E⁴) an organopolysiloxane having at least one organofunctional groups selected from amine, amide, isocyanurate, phenol, acrylate, epoxy, and thiol groups, (E⁵) a dehydrofluorination agent, and any combinations of (E¹), (E²), (E³), (E⁴) and (E⁵).

Organic compatibilizer (E¹) can be illustrated by compounds such as diallyphthalate, triallyl isocyanurate, 2,4,6-triallyloxy-1,3,5-triazine, triallyl trimesate, low molecular weight polybutadienes, 1,5-hexadiene, 1,7-octadiene, 2,2′-diallylbisphenol A, N,N′-diallyl tartardiamide, diallylurea, diallyl succinate and divinyl sulfone, inter alia.

Compatibilizer (E²) may be selected from linear, branched or cyclic organopolysiloxanes having at least 2 alkenyl groups in the molecule. Examples of such organopolysiloxanes include divinyltetramethyldisiloxane, cyclotrimethyltrivinyltrisiloxane, cyclo-tetramethyltetravinyltetrasiloxane, hydroxy end-blocked polymethylvinylsiloxane, hydroxy terminated polymethylvinylsiloxane-co-polydimethylsiloxane, dimethylvinylsiloxy terminated polydimethylsiloxane, tetrakis(dimethylvinylsiloxy)silane and tris(dimethylvinylsiloxy)phenylsilane. Alternatively, compatibilizer (B″) is a hydroxy terminated polymethylvinylsiloxane [HO(MeViSiO)ₓH] oligomer having a viscosity of about 25-100 mPa-s, containing 20-35% vinyl groups and 2-4% silicon-bonded hydroxy groups.

Compatibilizer (E³) is a silane which contains at least one alkylene group, typically comprising vinylic unsaturation, as well as at least one silicon-bonded moiety selected from hydrolyzable groups or a hydroxyl group. Suitable hydrolyzable groups include alkoxy, aryloxy, acyloxy or amido groups. Examples of such silanes are vinyltriethoxysilane, vinyltrimethoxysilane, hexenyltriethoxysilane, hexenyltrimethoxy, methylvinyldisilanol, octenyltriethoxysilane, vinyltriacetoxysilane, vinyltris(2-ethoxyethoxy)silane, methylvinylbis(N-methylacetamido)silane, methylvinyldisilanol.

Compatibilizer (E⁴) is an organopolysiloxane having at least one organofunctional groups selected from amine, amide, isocyanurate, phenol, acrylate, epoxy, and thiol groups.

Compatibilizer (E⁵) is a dehydrofluorination agent selected from alkaline metal oxides or hydroxides. The dehydrofluorination agent modifies the fluoroplastic via a dehydrofluorination reaction to form double bonds on the backbone. The resulting double bonds provide reactive sites for further reaction with other compatibilizers and/or silicone base (D). Typically the dehydrofluorination agent is an alkaline oxide or hydroxide selected from calcium hydroxide, magnesium hydroxide, calcium oxide, calcium hydroxide. When a dehydrofluorination agent is used, an agent used to cure fluorocarbon elastomers is preferably added. Non-limiting examples of these materials can be found in “Elucidation of Chemical Events Occurring in the Solid Phase during the Curing of Fluoroelastomers with Bidphenol AF”, by P. Ventateswarlu, R. E. Kolb, R. A. Guenthner, and T. A. Kestner, No. 123, Rubber Division, American Chemical Society, Detroit, Mich., Oct. 17-20, 1989.

It is possible that a portion of the curable organopolysiloxane of the silicone base component (A) described supra, can also function as a compatibilizer. For example, a cure agent (C) or catalyst (F) can be used to react a portion of the curable organopolysiloxane of silicone base (A) with the fluoroplastic to produce a modified fluoroplastic. In another chemical modification embodiment, during the dynamic vulcanization process, i.e. step (III), the cure chemistry occurring at the surface of the silicone compound can also react with the fluoroplastic, which furthers the dispersion of the silicone within the fluoroplastic.

The amount of compatibilizer used per 100 parts of fluoroplastic can be determined by routine experimentation. Typically, 0.05 to 15 parts by weight or alternatively 0.1 to 5 parts of the compatibilizer is used for each 100 parts of fluoroplastic.

Depending on the type of modification, typically, the compatibilizer can be added either to the silicone compound in step (I) or to the fluoroplastic prior to step (II) or to the plastic/silicone mixture during step (II).

Optional component (F) is a catalyst. Typically, the catalyst is used in the chemically modified embodiments. As such, it is typically a radical initiator selected from any organic compound which is known in the art to generate free radicals at elevated temperatures. The initiator is not specifically limited and may be any of the known azo or diazo compounds, such as 2,2′-azobisisobutyronitrile, but it is preferably selected from organic peroxides such as hydroperoxides, diacyl peroxides, ketone peroxides, peroxyesters, dialkyl peroxides, peroxydicarbonates, peroxyketals, peroxy acids, acyl alkylsulfonyl peroxides and alkyl monoperoxydicarbonates. A key requirement, however, is that the half life of the initiator be short enough so as to promote reaction of compatibilizer (E) with the fluoroplastic (D) or the silicone base (A) within the time and temperature constraints of the step (II) or step (III). The modification temperature, in turn, depends upon the type of fluoroplastic or silicone and compatibilizer chosen and is typically as low as practical consistent with uniform mixing of the components. Specific examples of suitable peroxides which may be used according to the method of the present invention include; 2,5-dimethyl-2,5-di(tert-butylperoxy)hexane; benzoyl peroxide; dicumyl peroxide; t-butyl peroxy O-toluate; cyclic peroxyketal; t-butyl hydroperoxide; vinyltris(t-butyl peroxy)silane; t-butyl peroxypivalate; lauroyl peroxide; t-amyl peroxy 2-ethylhexanoate; di-t-butyl peroxide; 1,3-bis(t-butylperoxyisopropyl) benzene; 2,2,4-trimethylpentyl-2-hydroperoxide; 2,5-bis(t-butylperoxy)-2,5-dimethylhexyne-3; t-butyl-peroxy-3,5,5-trimethylhexanoate;

cumene hydroperoxide; t-butyl peroxybenzoate and diisopropylbenzene mono hydroperoxide, inter alia. Less than 10 parts by weight of peroxide per 100 parts of the silicone base is typically used. Alternatively, 0.05 to 3 parts, and 0.1 to 1 parts, can also be employed.

Other than the specific limitations and process conditions associated with the selection of the catalyst as described above, step (II) can occur at a variety of conditions known in the art for effecting such mixing. Thus, mixing for step (II) can be effected in mixers, Banbury mixer, kneader, roller, or extrusion process.

In addition to the above-mentioned major components (A) through (F), one or more optional additives (G) can be incorporated in the fluoroplastic silicone compositions of the present invention. These optional additives can be illustrated by the following non-limiting examples: extending fillers such as quartz, calcium carbonate, and diatomaceous earth; pigments such as iron oxide and titanium oxide; fillers such as carbon black and finely divided metals; heat stabilizers such as hydrated cerric oxide, calcium hydroxide, magnesium oxide; flame retardants such as halogenated hydrocarbons, alumina trihydrate, magnesium hydroxide, wollastonite, organophosphorous compounds and other fire retardant (FR) materials; and other additives known in the art. These additives are typically added to the final composition after dynamic cure, but they may also be added at any point in the preparation provided they do not interfere with the dynamic vulcanization mechanism.

The third step (III) of the method of the present invention is dynamically vulcanizing the silicone compound. The dynamic vulcanizing step cures the organopolysiloxane.

Step (III) can occur simultaneous with step (II), or alternatively following step (II). Step (III) is effected by the same mixing procedures described for step (II).

The method of the present invention is characterized by first mixing the cure agent (C) with the silicone base (A) to form the silicone compound, prior to mixing with the fluoroplastic (D). Accordingly, the fluoroplastic silicone composition is typically prepared by mixing the silicone compound (product of step (I)) with a fluoroplastic (D), and optionally components (E) and (F) and then dynamically vulcanizing the silicone compound. Typically (G) would be added after step (III), but can be added anytime during the processing providing (G) does not interfere with cure of the silicone compound phase (e.g., (G) can be premixed with the fluoroplastic or with the silicone compound).

Mixing for all steps of the present method can be carried out in any device that is capable of uniformly dispersing the components, such as an internal mixer or a twin-screw extruder, the latter being preferred for commercial preparations. Any mixing techniques, known for mixing such materials, can be employed in the method of the present invention, including but not limited to mixers and Banbury mixers. Alternatively, extrusion processes can be employed. Alternatively, the mixing step (II), as well as the dynamic vulcanization step (III) of the present method can be accomplished by using a twin-screw extruder. By incorporating an elastomeric silicone into a fluoroplastic according to the present invention, the physical properties of the fluoroplastic silicone compositions are improved relative to the fluoroplastic alone. In a first embodiment, the impact resistance of the fluoroplastic is improved by incorporating at least 5 wt. % of the silicone base (A) with the fluoroplastic (D), as measured by Izod impact strength. In a second embodiment, the flex modulus of the fluoroplastic is improved by incorporating at least 25 wt. % of the silicone base (A) with the fluoroplastic (D), as measured by American Society of Testing Materials (ASTM) method D6272-02 Standard Test Method for FLEXURAL Properties of Unreinforced and Reinforced Plastics and Electrical Insulating Materials by Four-Point Bending or ASTM method D790-03 Standard Test Methods for FLEXURAL Properties of Unreinforced and Reinforced Plastics and Electrical Insulating Materials.

In the first embodiment of the present invention, fluoroplastic silicone compositions having improved impact resistance properties are provided by the present process wherein the weight ratio of fluoroplastic (D) to silicone base (A) in the fluoroplastic silicone composition ranges from 95:5 to 75:25. Impact strength, as used herein, is notched Izod impact strength as measured on a sample having a length of 62 mm and a width of 3.5 mm and a thickness of 12.7 mm, according to ASTM method D 256-95 (Method A) at room temperature (approximately 25° C.). Briefly, this test measures the amount of energy required to break a notched specimen by a swinging pendulum hammer. Typically, fluoroplastic silicone compositions of the present invention have an average impact energy of at least 50% higher than fluoroplastics resin alone.

In the second embodiment of the present invention, fluoroplastic silicone compositions having improved impact modification properties are provided by the present process wherein the weight ratio of fluoroplastic (D) to silicone base (A) in the fluoroplastic silicone composition ranges from 25:75 to 75:25. For purposes of this invention, flex modulus of the resulting fluoroplastic silicone composition, measured according to ASTM methods D6272-02 or D790-03, are typically, at least 25% lower than fluoroplastic alone.

Additional components can be added to the fluoroplastic silicone composition. These include blending other fluoroplastics or other fluoroplastic silicone compositions into the fluoroplastic silicone composition of the present invention. These additional components can also be any component or ingredient typically added to a fluoroplastics. Typically, these components can be selected from fillers and processing aids. Many commercially available fluoroplastics can already comprise these additional components.

A fluoroplastic silicone composition of the present invention can be processed by conventional techniques, such as extrusion, vacuum forming, injection molding, blow molding or compression molding, to fabricate plastic parts. Moreover, these compositions can be re-processed (recycled) with little or no degradation of mechanical properties. These novel fluoroplastic elastomers find utility in areas not limited to the fabrication of wire and cable insulation, such as plenum wire, automotive and appliance components, belts, hoses, construction seals and in general rubber applications.

### EXAMPLES

The following examples are presented to further illustrate the compositions and method of this invention, but are not construed as limiting the invention, which is delineated in the appended claims. All parts and percentages in the examples are on a weight basis and all measurements were obtained at approximately 23° C., unless otherwise indicated.

Materials

GP-50 is a silicone rubber base marketed by Dow Corning Corporation as Silastic® GP-50.

GP-700 is a silicone rubber base marketed by Dow Corning Corporation as Silastic® GP-700.

TRIG A-W70 is a solution of 70% tert-butyl hydroperoxide (CAS#75-91-2) in 30% water marketed by Akzo Nobel Chemicals, Inc. as TRIGONOX® A-W70.

VAROX is 2,5-dimethyl-2,5-di(tert-butylperoxy)hexane on an inert filler marketed by R. T. Vanderbilt, Company, Inc. as VAROX® DBPH-50.

COMPATIBILIZER 1 is a hydroxy end-blocked methylvinylsiloxane oligomer having a viscosity of about 35 mPa-s and containing 30%-CH═CH₂ groups and 3% OH groups.

Kynar 460 is a polyvinylidene fluoride (PVDF) homopolymer and is marketed by ATOFINA Chemicals, Inc. as Kynar® homopolymer series 460.

Kynar 3120-50 is a polyvinylidene fluoride (PVDF) copolymer and is marketed by ATOFINA Chemicals, Inc. as Kynar® Flex Copolymer 3120-50.

THV220G is a fluorinated terpolymer of tetrafluoroethylene, hexafluoropropylene and vinylidene fluoride marketed by Dyneon, LLC as Dyneon™ THV 220G Fluorothermoplastic.

Testing

The tensile, elongation, and 100% modulus properties of the cured elastomeric base compositions were measured by a procedure is based on ASTM D 412. Shore A Durometer was measured by a procedure is based on ASTM D 2240.

### Example 1

GP-700 (100 parts) and AW-70 (1.5 parts) were mixed on a 2-roll mill to form a silicone compound. Kynar 460 (280 g) was added to a 379 ml Haake mixer equipped with banbury rotors at 190° C. and 125 rpm (revolutions per minute). The silicone compound (120 g) was added when the internal temperature of the fluoroplastic was 180° C. After a torque increase, the material temperature was about 220° C. The fluoroplastic elastomeric composition was removed at 10 minutes.

Upon cooling, compression molded to give a Shore A Durometer of 94, A Tensile Strength of 17.6 MPa, an Elongation 52%.

### Example 2

GP-700 (100 parts) and AW-70 (1.5 parts) were mixed on a 2-roll mill to form a silicone compound. Kynar 3120-50 (280 g) was added to a 379 ml Haake mixer equipped with banbury rotors at 190° C. and 125 rpm (revolutions per minute). The silicone compound (120 g) was added when the internal temperature of the fluoroplastic was 180° C. After a torque increase, the material temperature was about 220° C. The fluoroplastic elastomeric composition was removed at 9 minutes.

Upon cooling, compression molded to give a Tensile Strength of 8.2 MPa, an Elongation 31%.

### Example 3

GP-50 (100 parts), Compatibilizer 1 (2.38 parts) and Varox (4.76 parts) were mixed on a 2-roll mill to form a silicone compound. THV220G (288 g) and the silicone compound (117.68 g) were added to a 379 ml Haake mixer equipped with banbury rotors at 150° C. and 125 rpm (revolutions per minute). After a torque increase, the material temperature was about 240° C. The fluoroplastic elastomeric composition was removed at 9 minutes.

Upon cooling, compression molded to give a Shore A Durometer of 80, a Tensile Strength of 9.0 MPa, an Elongation 375%.

1. A method for preparing a fluoroplastic composition comprising:
(I) mixing
(A) a fluorocarbon resin having a glass transition temperature above 23° C.,
(B) a compatibilizer,
(C) an optional catalyst,
(II) mixing the product of step (I) with
(D) a silicone base comprising a curable organopolysiloxane,
(E) a radical initiator in an amount sufficient to cure said
organopolysiloxane; and
(III) vulcanizing the organopolysiloxane,
wherein the weight ratio of fluorocarbon resin (A) to silicone base (D) in the elastomeric base composition ranges from 95:5 to 30:70.

2. The method of claim 1 wherein the fluorocarbon resin (A) is a fluoroplastic homopolymer, copolymer, or terpolymer comprising monomers selected from the group of tetrafluoroethylene, hexafluoropropylene, chlorotrifluoroethylene, and vinylidene fluoride monomers.

3. The method of claim 1 wherein the compatibilizer (B) is selected from the group of (B′) organic compounds which contain 2 or more olefin groups, (B″) organopolysiloxanes containing at least 2 alkenyl groups and (B′″) olefin-functional silanes which also contain at least one hydrolyzable group or at least one hydroxyl group attached to a silicon atom thereof.

4. The method of claim 1 wherein the compatibilizer (B) is a hydroxy end-blocked methyl vinyl siloxane.

5. The method of claim 1 wherein optional catalyst (C) is present and is an organic peroxide.

6. The method of claim 1 wherein the curable organopolysiloxane is a diorganopolysiloxane gum containing at least 2 alkenyl groups having 2 to 20 carbon atoms and having a sufficient molecular weight to impart a Williams plasticity number of at least 30 as determined by the American Society for Testing and Materials (ASTM) test method D 926.

7. The method of claim 1 wherein the radical initiator is an organic peroxide.

8. The method of claim 1 wherein the vulcanization of step (III) is a dynamic vulcanization.

9. The method of claim 8 wherein the dynamic vulcanization occurs via an extrusion process.

10. The method of claim 9 wherein the extrusion process occurs in a twin screw extruder.

11. The method of claim 1 wherein the vulcanization of step (III) is a static vulcanization.

12. A fluoroplastic composition produced by the method of claim 1.

13. An article of manufacture comprising the fluoroplastic composition of claim 12.
